(19) United States
(12) Patent Application Publication
(10) Pub. No.: US 2010/0232769 A1
(43) Pub. Date: Sep. 16, 2010

(54) BANDWIDTH CONTROL METHOD, DEVICE AND SYSTEM

(76) Inventor: Lei Zhao, Shenzhen (CN)

Correspondence Address: Huawei/BHGL, P.O. Box 10395, Chicago, IL, 60610, US

(21) Appl. No.: 12/722,940

(22) Filed: Mar. 12, 2010

(30) Foreign Application Priority Data
Mar. 13, 2009 (CN) 200910117879.7

(51) Int. Cl. H04N 7/12; H04N 7/26; H04B 1/66

(52) U.S. Cl. 386/124; 375/240.02; 375/E07.126; 386/E05.003

(57) ABSTRACT

A bandwidth control method, a bandwidth control device, and a bandwidth control system are provided. In the method, complexity information about the current video sequence of a video signal in each channel is acquired. Then, the complexity information about the current video sequence of the video signal in each channel is quantified, and a current-video-sequence complexity level of the video signal in each channel is obtained according to the complexity information. Finally, a total bandwidth is distributed to the video signal in each channel according to the current-video-sequence complexity level of the video signal in each channel. Therefore, a bandwidth is dynamically distributed to the video signal in each channel. In this way, the total bandwidth can be reasonably utilized, and an occurrence probability of video quality deterioration can be lowered.

### CROSS-REFERENCE TO RELATED APPLICATION

This application claims priority to Chinese Patent Application No. 200910117879.7, filed on Mar. 13, 2009, which is hereby incorporated by reference in its entirety.

### FIELD OF THE TECHNOLOGY

The present invention relates to the field of communications technology, and more particularly to a bandwidth control method, a bandwidth control device, and a bandwidth control system.

### BACKGROUND OF THE INVENTION

Currently, an apparatus formed by a digital video server (DVS) and a digital video recorder (DVR), also called a DVS/DVR apparatus, is usually applied to the implementation of the monitoring and security protecting functions. The DVS/DVR apparatus is mainly adapted to encode video signals of various video capturing apparatuses for monitoring and videography, so as to transmit and store the video signals. During the practical application, to improve the integrity of the system, one DVS/DVR apparatus generally supports the encoding of video signals from multiple channels, and then transmits the encoded video signals to a remote end via a network transmission channel, so as to monitor and store the video. For example, when monitoring a cross road, usually the four crossings need to be monitored at the same time, so that the four crossings require the encoding operation at the same time, and then the encoded signals are transmitted to a remote end via a network channel.

FIG. 1 is a schematic diagram of a logical structure of a DVS/DVR apparatus in the prior art. Referring to FIG. 1, the DVS/DVR apparatus includes a control module 101 and several encoding modules 102. The encoding module 102 is mainly adapted to receive a video signal, encode the video signal (for example, moving picture experts group (MPEG) 4/H.264 encoding), and input the encoded video signal to the control module 101. The control module 101 is mainly adapted to allocate a total output bandwidth for each encoding module 102, pack an encoded code stream sent by each encoding module 102, and encapsulate the encoded code streams to be transmitted over a network (for example, an Internet Protocol (IP) network). In the DVS/DVR apparatus as shown in FIG. 1, the control module 101 separately allocates an independent and unchanged bandwidth for the video signal received by each encoding module 102, and the sum of the bandwidths for the video signals in multiple channels received by all the encoding modules 102 is equal to the total output bandwidth allocated by the control module 101.

When implementing the present invention, the inventor found that, the bandwidth for a video signal in each channel is pre-distributed in the DVS/DVR apparatus of the prior art, and when the content of the video signal in a certain channel is suddenly changed, for example, a person runs quickly or a car pass away suddenly, a serious blocking artifact may occur to the video signal in the channel due to the insufficient bandwidth, so that the video quality is seriously deteriorated. When a video signal in a certain channel is quite simple, for example, the car is stopped when the traffic light turns red, the actual bandwidth of the video signal required in the channel may be smaller than the pre-distributed bandwidth, so that the additional bandwidth is left unused.

### SUMMARY OF THE INVENTION

The present invention is directed to a bandwidth control method, a bandwidth control device, and a bandwidth control system, which are capable of dynamically distributing a bandwidth to a video signal in each channel, so as to reasonably utilize a total bandwidth and lower an occurrence probability of video quality deterioration.

To achieve the above objectives, the present invention provides the following technical solutions.

In an embodiment, the present invention provides a bandwidth control method, which includes the following steps:

Complexity information about the current video sequence of a video signal in each channel is acquired.
The complexity information about the current video sequence of the video signal in each channel is quantified, and a current-video-sequence complexity level of the video signal in each channel is obtained according to the complexity information.
A bandwidth of the video signal in each channel is distributed according to the current-video-sequence complexity level of the video signal in each channel.

In an embodiment, the present invention provides a bandwidth control device, which includes an acquiring module, a quantifying module, and a distributing module;

The acquiring module is adapted to acquire complexity information about the current video sequence of a video signal in each channel.
The quantifying module is adapted to quantify the complexity information about the current video sequence of the video signal in each channel, and obtain a current-video-sequence complexity level of the video signal in each channel according to the complexity information.
The distributing module is adapted to distribute a bandwidth to the video signal in each channel according to the current-video-sequence complexity level of the video signal in each channel.

In an embodiment, the present invention provides a video signal processing device, which is applicable to acquire and process video signals in several channels, and includes a first receiving module, an encoding module, a second receiving module, a quantifying module, a distributing module, a quantifying sub-module, and a determination module.

The first receiving module is adapted to receive a video signal in each channel provided by a video capturing device.
The encoding module is adapted to encode the video signal in each channel, and obtain complexity information about the current video sequence of the video signal in each channel.
The second receiving module is adapted to receive the complexity information about the current video sequence of the video signal in each channel sent by the encoding module.
The quantifying module is adapted to quantify the complexity information about the current video sequence of the video signal in each channel, and obtain a current-video-sequence complexity level of the video signal in each channel according to the complexity information.
The distributing module is adapted to distribute a bandwidth to the video signal in each channel according to the current-video-sequence complexity level of the video signal in each channel.
The quantifying sub-module is adapted to quantify the complexity information about the current video sequence of the video signal in each channel, and obtain a quantified value of the complexity information about the current video sequence of the video signal in each channel.
The determination module is adapted to determine the current-video-sequence complexity level of the video signal in each channel according to the quantified value of the complexity information about the current video sequence of the video signal in each channel.

In an embodiment, the present invention further provides a bandwidth control system, which includes a video capturing device and a video signal processing device.

The video capturing device is adapted to capture a video signal in each channel.
The video signal processing device is adapted to receive the video signal in each channel provided by the video capturing device; encode the video signal in each channel, and obtain complexity information about the current video sequence of the video signal in each channel; quantify the complexity information about the current video sequence of the video signal in each channel, and obtain a current-video-sequence complexity level of the video signal in each channel according to the complexity information; and distribute a bandwidth to the video signal in each channel according to the current-video-sequence complexity level of the video signal in each channel.

In the embodiments of present invention, a total bandwidth can be dynamically distributed to a video signal in each channel according to a different complexity level of the video signal in each channel, so that the video signal in each channel dynamically obtains a proper bandwidth, so as to reasonably utilize the total bandwidth and lower the occurrence probability of video quality deterioration in the case that the total bandwidth remains unchanged.

### BRIEF DESCRIPTION OF THE DRAWINGS

To illustrate the technical solutions according to the embodiments of the present invention or in the prior art more clearly, the accompanying figures for describing the embodiments or the prior art are introduced briefly in the following. Apparently, the accompanying drawings in the following description are only some embodiments of the present invention, and persons of ordinary skill in the art can obtain other drawings according to the accompanying drawings without making creative efforts.

FIG. 1 is a schematic diagram of a logical structure of a DVS/DVR apparatus in the prior art;

FIG. 2 is a schematic flow chart of a bandwidth control method according to a first embodiment of the present invention;

FIG. 3 is a schematic flow chart of a bandwidth control method according to a second embodiment of the present invention;

FIG. 4 is a schematic diagram of a logical structure of a bandwidth control device according to a third embodiment of the present invention;

FIG. 5 is a schematic diagram of a logical structure of an acquiring module according to the third embodiment of the present invention;

FIG. 6 is a schematic diagram of a logical structure of a quantifying module according to the third embodiment of the present invention;

FIG. 7 is a schematic diagram of a logical structure of a distributing module according to the third embodiment of the present invention;

FIG. 8 is a schematic diagram of a logical structure of a video signal processing device according to a fourth embodiment of the present invention; and

FIG. 9 is a schematic diagram of a logical structure of a bandwidth control system according to a fifth embodiment of the present invention.

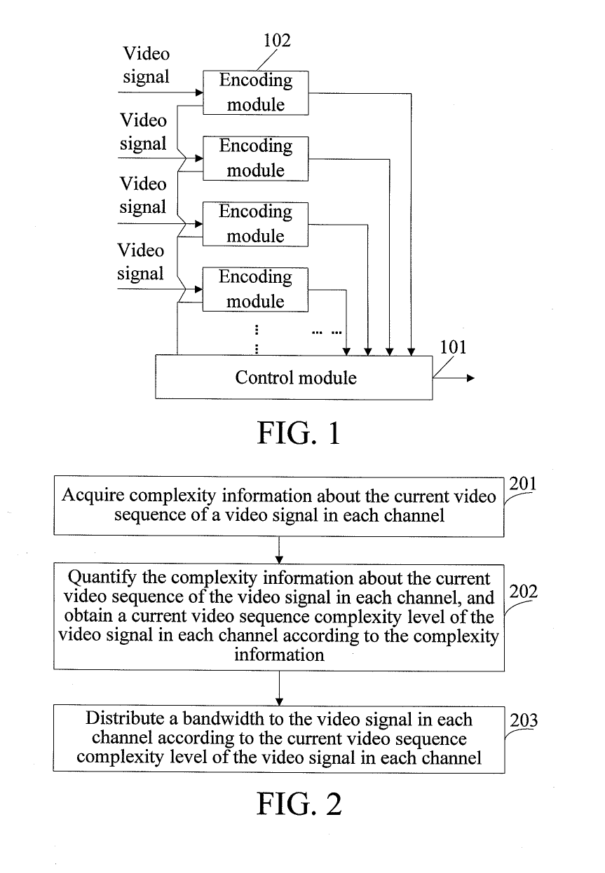

### DETAILED DESCRIPTION OF THE EMBODIMENTS

The technical solutions of the present invention embodiments are clearly and fully described below with reference to the accompanying drawings. It is obvious that the embodiments to be described are only part rather than all of the embodiments of the present invention. All other embodiments derived by persons skilled in the art based on the embodiments of the present invention without making creative efforts should fall within the scope of the present invention.

### First Embodiment

FIG. 2 is a schematic flow chart of a bandwidth control method according to a first embodiment of the present invention. Referring to FIG. 2, the method includes the following steps.

In step 201, complexity information about the current video sequence of a video signal in each channel is acquired.

Particularly, the complexity information about the current video sequence of the video signal in each channel sent by an encoding module corresponding to the video signal in each channel is received.

The complexity information about the current video sequence of the video signal in each channel is sent by the encoding module corresponding to the video signal in each channel after the encoding module encodes a current video sequence of an input video signal in one channel.

In step 202, the complexity information about the current video sequence of the video signal in each channel is quantified, and a current-video-sequence complexity level of the video signal in each channel is obtained according to the complexity information.

Particularly, by quantifying the complexity information about the current video sequence of the video signal in each channel, a quantified value of the complexity information about the current video sequence of the video signal in each channel is further obtained.

Then, the current-video-sequence complexity level of the video signal in each channel is determined according to the quantified value of the complexity information about the current video sequence of the video signal in each channel.

In step 203, a bandwidth is distributed to the video signal in each channel according to the current-video-sequence complexity level of the video signal in each channel.

For example, a proportional relationship among the current-video-sequence complexity levels of the video signals in each channel is calculated, and the bandwidth is distributed to the video signal in each channel according to the proportional relationship among the current-video-sequence complexity levels of the video signals in each channel.

Alternatively, the bandwidth is distributed to the video signal in each channel according to the proportional relationship among the current-video-sequence complexity levels of the video signals in each channel together with a preset priority of the video signal in each channel.

The priority of the video signal in each channel is adapted to indicate a significance degree of the video signal in each channel.

In the embodiment of the present invention, a total bandwidth can be dynamically distributed to a video signal in each channel according to a different complexity level of the video signal in each channel, so that the video signal in each channel dynamically obtains a proper bandwidth, so as to reasonably utilize the total bandwidth and lower the occurrence probability of video quality deterioration in the case that the total bandwidth remains unchanged.

### Second Embodiment

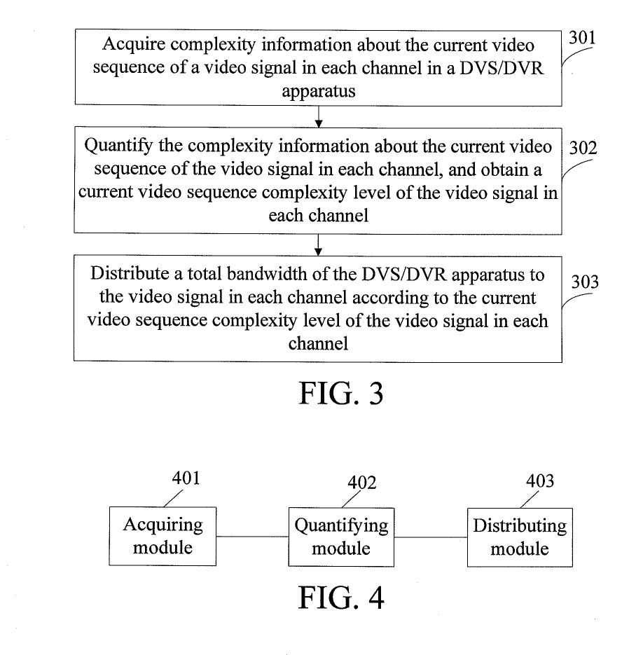

FIG. 3 is a schematic flow chart of a bandwidth control method according to a second embodiment of the present invention. In this embodiment of the present invention, a bandwidth control method according to this embodiment of the present invention is introduced by taking the process of controlling a bandwidth of a video signal in each channel in a DVS/DVR apparatus as an example. Referring to FIG. 3, the method includes the following steps.

In step 301, complexity information about the current video sequence of a video signal in each channel in a DVS/DVR apparatus is acquired.

The existing DVS/DVR apparatus supports a plurality of encoding modules (AV Enc) at the same time, and each encoding module may encode an input video signal in one channel through, for example, MPEG4 encoding, or H.264 encoding.

Each encoding module receives the video signal by taking a sequence as a unit, or in other words, the video signal is input to each encoding module by taking the sequence as a unit. By encoding a current video sequence of a video signal in one channel, one encoding module obtains complexity information about the current video sequence of the video signal in the channel.

By receiving the complexity information about the current video sequence of the video signal in each channel output by each encoding module, the complexity information about the current video sequence of the video signal in each channel in the DVS/DVR apparatus is acquired.

The complexity information about the current video sequence of the video signal in each channel particularly includes, but not limited to, a peak signal to noise ratio (PSNR) of a current video sequence of the video signal in the channel.

In step 302, the complexity information about the current video sequence of the video signal in each channel is quantified, and a current-video-sequence complexity level of the video signal in each channel is obtained.

The complexity information about the current video sequence of the video signal in each channel in the DVS/DVR apparatus acquired in step 301 is separately quantified by adopting various quantifying manners in the prior art, for example, A-law companding or μ-law companding, so as to obtain a quantified value of the complexity information about the current video sequence of the video signal in each channel.

The obtained quantified value of the complexity information about the current video sequence of the video signal in each channel is classified into different levels, so as to obtain a complexity level of the video signal in each channel. For example, when the quantified value of the complexity information about the current video sequence is 0-1, the current-video-sequence complexity level of the video signal in the channel is 1; when the quantified value of the complexity information about the current video sequence is 1-2, the current-video-sequence complexity level of the video signal in the channel is 2; when the quantified value of the complexity information about the current video sequence is 3-4, the current-video-sequence complexity level of the video signal in the channel is 3; . . . ; and so forth.

Definitely, other level classification manners may also be adopted, for example, when the quantified value of the complexity information about the current video sequence is 0-3, the current-video-sequence complexity level of the video signal in the channel is 1; when the quantified value of the complexity information about the current video sequence is 3-8, the current-video-sequence complexity level of the video signal in the channel is 2; when the quantified value of the complexity information about the current video sequence is higher than 8, the current-video-sequence complexity level of the video signal in the channel is the highest level 3. In the present invention, the specific level classification is not limited.

In step 303, a total bandwidth of the DVS/DVR apparatus is distributed to the video signal in each channel according to the current-video-sequence complexity level of the video signal in each channel.

Because the video signals are continuous, the bandwidth distributed to a current video sequence may serve as a recommended value for a next video sequence, and the encoding module may encode the video signal of the next video sequence according to the recommended value for the next video sequence, so as to continue to obtain complexity information of a subsequent video signal.

A distributing policy of distributing the total bandwidth of the DVS/DVR apparatus to the video signal in each channel according to the current-video-sequence complexity level of the video signal in each channel includes, but not limited to, the following two types.

1) A proportional relationship among the current-video-sequence complexity level of the video signal in each channel is calculated, and the total bandwidth of the DVS/DVR apparatus is distributed to the video signal in each channel according to the proportional relationship.

For example, it is assumed that the DVS/DVR apparatus totally supports video signals in the channels 1, 2, 3, and 4, the video signal in each channel is separately input to one encoding module, and the total bandwidth of the DVS/DVR apparatus is 100 M.

It is further assumed that the proportional relationship among the current-video-sequence complexity levels of the video signals in the channels 1, 2, 3, and 4 is 1:2:4:1, and when the total bandwidth of 100 M is distributed to the video signals in the channels 1, 2, 3, and 4, the bandwidths obtained by the video signals in the channels 1, 2, 3, and 4 are respectively 12.5 M, 25 M, 50 M, and 12.5 M.

2) The proportional relationship among the current-video-sequence complexity level of the video signal in each channel is calculated, and the total bandwidth of the DVS/DVR apparatus is distributed to the video signal in each channel according to the proportional relationship together with a priority order of the video signal in each channel.

For example, it is assumed that the DVS/DVR apparatus totally supports video signals in the channels 1, 2, and 3, the video signal in each channel is separately input to one encoding module, and a total bandwidth of the DVS/DVR apparatus is 120 M.

It is further assumed that the proportional relationship among the current-video-sequence complexity levels of the video signals in the channels 1, 2, and 3 is 1:2:3, and priority orders of the video signals in the channels 1, 2, and 3 are respectively a third priority, a second priority, and a first priority. When the total bandwidth of 120 M is distributed to the video signals in the channels 1, 2, and 3, a bandwidth of 60 M is firstly distributed to the video signal in the channel 3, then a bandwidth of 40 M is distributed to the video signal in the channel 2, and finally a bandwidth of 20 M is distributed to the video signal in the channel 1.

It should be noted that, the priority of a video signal is adapted to indicate the significance of the video signal. The bandwidth required by a video signal with a high significance is preferentially satisfied, and then the bandwidth required by a video signal with a low significance is further satisfied. After the bandwidth required by the video signal with the high significance is satisfied, if the bandwidth required by the video signal with the low significance cannot be satisfied due to the insufficient bandwidth, the quality of the video signal with the low significance is sacrificed, so that the quality of the video signal with the high significance remains unchanged. Definitely, the priority of the video signal may not be set, which indicates that the video signal in each channel has the same significance. In this case, the bandwidth required by the video signal in each channel may be satisfied randomly, or it is defaulted that the bandwidth required by the video signal in each channel is satisfied beginning from the video signal in the first channel.

In the method according to the embodiment of the present invention, the higher the current-video-sequence complexity level of the video signal is, the larger the bandwidth distributed to the video signal in the channel will be. On the contrary, the lower the current-video-sequence complexity level of the video signal is, the smaller the bandwidth distributed to the video signal in the channel is. In addition, the higher the priority of the video signal is, and the higher the current-video-sequence complexity level of the video signal is, the quicker and the larger the bandwidth distributed to the video signal in the channel will be. On the contrary, the lower the priority of the video signal is, and the lower the current-video-sequence complexity level of the video signal is, the slower and the smaller the bandwidth distributed to the video signal in the channel is.

The bandwidth control method according to the embodiment of the present invention has been introduced. In the embodiment of the present invention, the total bandwidth can be dynamically distributed to the video signal in each channel in the case that the total bandwidth of the DVS/DVR apparatus remains unchanged, so that the video signal in each channel dynamically obtains a proper bandwidth, so as to reasonably utilize the total bandwidth, and further lower the occurrence probability of video quality deterioration.

### Third Embodiment

FIG. 4 is a schematic diagram of a logical structure of a bandwidth control device according to a third embodiment of the present invention. The bandwidth control device according to the third embodiment of the present invention may serve as a bandwidth control device independent from a DVS/DVR apparatus, which is adapted to control a bandwidth of a video signal in each channel among video signals in multiple channels supported in the DVS/DVR apparatus. Alternatively, the bandwidth control device may serve as a part of the DVS/DVR apparatus, which is adapted to control a bandwidth of a video signal in each channel among video signals in multiple channels supported in the DVS/DVR apparatus. The present invention is not limited here.

Referring to FIG. 4, the device includes an acquiring module 401, a quantifying module 402, and a distributing module 403.

The acquiring module 401 is adapted to acquire complexity information about the current video sequence of a video signal in each channel.

The quantifying module 402 is adapted to quantify the complexity information about the current video sequence of the video signal in each channel acquired by the acquiring module 401, and obtain a current-video-sequence complexity level of the video signal in each channel.

The distributing module 403 is adapted to distribute a total bandwidth to the video signal in each channel according to the current-video-sequence complexity level of the video signal in each channel obtained by the quantifying module 402 through quantification.

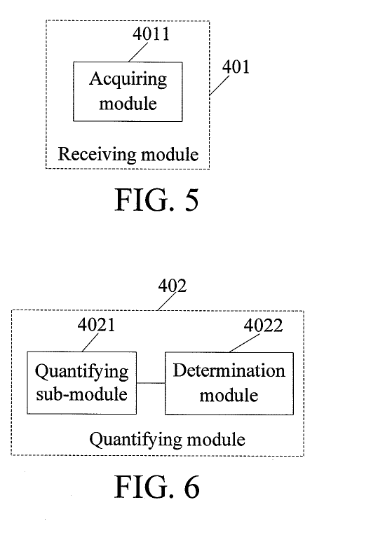

FIG. 5 is a schematic diagram of a logical structure of the acquiring module 401 according to the third embodiment of the present invention. Referring to FIG. 5, the acquiring module 401 includes a receiving module 4011.

The receiving module 4011 is adapted to receive the complexity information about the current video sequence of the video signal in each channel sent by each encoding module.

Preferably, the complexity information about the current video sequence of the video signal in each channel particularly includes, but not limited to, a PSNR of a current video sequence of the video signal in the channel.

FIG. 6 is a schematic diagram of a logical structure of the quantifying module 402 according to the third embodiment of the present invention. Referring to FIG. 6, the quantifying module 402 includes a quantifying sub-module 4021 and a determination module 4022.

The quantifying sub-module 4021 is adapted to quantify the complexity information about the current video sequence of the video signal in each channel acquired by the acquiring module 401, and obtain a quantified value of the complexity information about the current video sequence of the video signal in each channel.

The quantifying sub-module 4021 separately quantifies the complexity information about the current video sequence of the video signal in each channel acquired by the acquiring module 401 by adopting various quantifying manners in the prior art, for example, A-law companding or μ-law companding, so as to obtain the quantified value of the complexity information about the current video sequence of the video signal in each channel.

The determination module 4022 is adapted to determine the current-video-sequence complexity level of the video signal in each channel according to the quantified value of the complexity information about the current video sequence of the video signal in each channel obtained by the quantifying sub-module 4021 through quantification.

Particularly, the determination module 4022 classifies the quantified value of the complexity information about the current video sequence of the video signal in each channel quantified by the quantifying sub-module 4021 into different levels, so as to obtain the complexity level of the video signal in each channel. For example, when the quantified value of the complexity information about the current video sequence is 0-1, the current-video-sequence complexity level of the video signal in the channel is 1; when the quantified value of the complexity information about the current video sequence is 1-2, the current-video-sequence complexity level of the video signal in the channel is 2; when the quantified value of the complexity information about the current video sequence is 3-4, the current-video-sequence complexity level of the video signal in the channel is 3; . . . ; and so forth.

Definitely, other level classification manners may also be adopted, for example, when the quantified value of the complexity information about the current video sequence is 0-3, the current-video-sequence complexity level of the video signal in the channel is 1; when the quantified value of the complexity information about the current video sequence is 3-8, the current-video-sequence complexity level of the video signal in the channel is 2; when the quantified value of the complexity information about the current video sequence is higher than 8, the current-video-sequence complexity level of the video signal in the channel is the highest level 3. In the present invention, the specific level classification is not limited here.

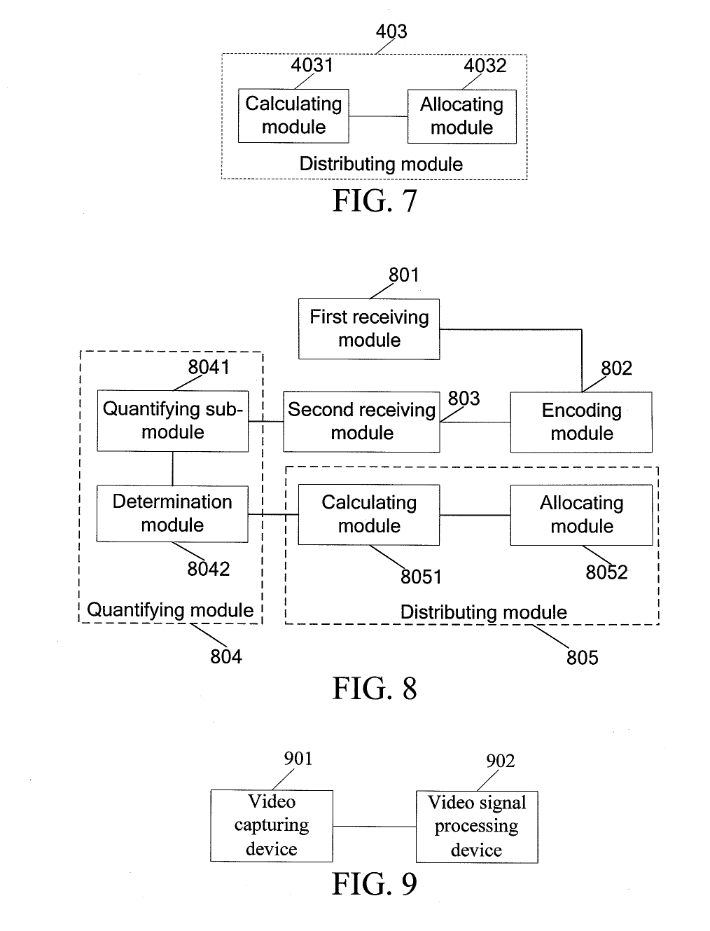

FIG. 7 is a schematic diagram of a logical structure of the distributing module 403 according to the third embodiment of the present invention. Referring to FIG. 7, the distributing module 403 includes a calculating module 4031 and an allocating module 4032.

The calculating module 4031 is adapted to calculate the proportional relationship among the current-video-sequence complexity level of the video signal in each channel obtained by the quantifying module 402 through quantification.

The allocating module 4032 is adapted to distribute the bandwidth to the video signal in each channel according to the proportional relationship among the current-video-sequence complexity level of the video signal in each channel calculated by the calculating module 4031.

For example, it is assumed that video signals in the channels 1, 2, 3, and 4 exist at the same time, the video signal in each channel is separately input to one encoding module, and a total bandwidth is 100 M.

It is further assumed that the proportional relationship among the current-video-sequence complexity levels of the video signals in the channels 1, 2, 3, and 4 calculated by the calculating module 4031 is 1:2:4:1, and when the allocating module 4032 distributes the total bandwidth of 100 M to the video signals in the channels 1, 2, 3, and 4, the bandwidths obtained by the video signals in the channels 1, 2, 3, and 4 are respectively 12.5 M, 25 M, 50 M, and 12.5 M.

When the video signal in each channel further has a priority, the allocating module 4032 is particularly adapted to distribute the total bandwidth to the video signal in each channel according to the proportional relationship among the current-video-sequence complexity level of the video signal in each channel calculated by the calculating module 4031 together with a priority order of the video signal in each channel.

For example, it is assumed that video signals in the channels 1, 2, and 3 exist at the same time, the video signal in each channel is separately input to one encoding module, and a total bandwidth is 120 M.

It is further assumed that the proportional relationship among the current-video-sequence complexity levels of the video signals in the channels 1, 2, and 3 calculated by the calculating module 4031 is 1:2:3, and priority orders of the video signals in the channels 1, 2, and 3 are respectively a third priority, a second priority, and a first priority. When the allocating module 4032 distributes the total bandwidth of 120 M to the video signals in the channels 1, 2, and 3, a bandwidth of 60 M is firstly distributed to the video signal in the channel 3, then a bandwidth of 40 M is distributed to the video signal in the channel 2, and finally a bandwidth of 20 M is distributed to the video signal in the channel 1.

It should be noted that, the bandwidth control device according to the third embodiment of the present invention is adapted to control the bandwidth of the video signal in each channel among video signals in multiple channels in the DVS/DVR apparatus, and is also adapted to control a bandwidth of a video signal in each channel in an apparatus or a device capable of supporting the encoding of video signals in multiple channels similar to the DVS/DVR apparatus, and the present invention is not limited here.

Through the bandwidth control device according to the third embodiment of the present invention, when the content of a video signal in a certain channel is suddenly changed, the bandwidth of the video signal in the channel is increased, and the bandwidth of the video signal in the other one or several channels is reduced, so as to dynamically distribute the bandwidth to the video signal in each channel and further lower the occurrence probability of video quality deterioration while maintaining the total bandwidth unchanged.

### Fourth Embodiment

FIG. 8 is a schematic diagram of a logical structure of a video signal processing device according to a fourth embodiment of the present invention. The video signal processing device according to the embodiment of the present invention is applicable to acquire and process video signals in several channels. Referring to FIG. 8, the video signal processing device includes a first receiving module 801, an encoding module 802, a second receiving module 803, a quantifying module 804, and a distributing module 805.

The first receiving module 801 is adapted to receive a video signal in each channel provided by a video capturing device.

Particularly, the first receiving module 801 receives the video signal in each channel input by external cameras and other video capturing devices, and sends the received video signal in each channel to the encoding module 802.

The encoding module 802 is adapted to encode the video signal in each channel sent by the first receiving module 801, and obtain complexity information about the current video sequence of the video signal in each channel.

Particularly, the encoding module 802 performs MPEG4/H.264 encoding on the video signal in each channel input by the first receiving module 801, and obtains and sends the complexity information about the current video sequence of the video signal in each channel to the second receiving module 803.

The second receiving module 803 is adapted to receive the complexity information about the current video sequence of the video signal in each channel sent by the encoding module 802.

Particularly, the complexity information about the current video sequence of the video signal in each channel sent by the encoding module 802 includes, but not limited to, a PSNR of a current video sequence of the video signal in the channel.

The quantifying module 804 is adapted to quantify the complexity information about the current video sequence of the video signal in each channel sent by the second receiving module 803, and obtain a current-video-sequence complexity level of the video signal in each channel according to the complexity information.

It should be noted that, the quantifying module 804 in the embodiment of the present invention has the same logical structure as that of the quantifying module in the third embodiment as shown in FIG. 6, and includes a quantifying sub-module 8041 and a determination module 8042.

The quantifying sub-module 8041 is adapted to quantify the complexity information about the current video sequence of the video signal in each channel sent by the second receiving module 803, and obtain a quantified value of the complexity information about the current video sequence of the video signal in each channel.

Particularly, the quantifying sub-module 8041 quantifies the complexity information about the current video sequence of the video signal in each channel sent by the second receiving module 803, and obtains the quantified value of the complexity information about the current video sequence of the video signal in each channel.

The quantifying sub-module 8041 separately quantifies the complexity information about the current video sequence of the video signal in each channel sent by the second receiving module 803 by adopting various quantifying manners in the prior art, for example, A-law companding or μ-law companding, so as to obtain the quantified value of the complexity information about the current video sequence of the video signal in each channel.

The determination module 8042 is adapted to determine the current-video-sequence complexity level of the video signal in each channel according to the quantified value of the complexity information about the current video sequence of the video signal in each channel.

Particularly, the determination module 8042 classifies the quantified value of the complexity information about the current video sequence of the video signal in each channel into different levels, so as to obtain the complexity level of the video signal in each channel. For example, when the quantified value of the complexity information about the current video sequence is 0-1, the current-video-sequence complexity level of the video signal in the channel is 1; when the quantified value of the complexity information about the current video sequence is 1-2, the current-video-sequence complexity level of the video signal in the channel is 2; when the quantified value of the complexity information about the current video sequence is 3-4, the current-video-sequence complexity level of the video signal in the channel is 3; . . . ; and so forth.

The distributing module 805 is adapted to distribute a bandwidth to the video signal in each channel according to the current-video-sequence complexity level of the video signal in each channel.

It should be noted that, the distributing module 805 in the embodiment of the present invention has the same logical structure as that of the distributing module in the third embodiment as shown in FIG. 7, and includes a calculating module 8051 and an allocating module 8052.

The calculating module 8051 is adapted to calculate a proportional relationship among the current-video-sequence complexity level of the video signal in each channel obtained by the quantifying module 804 through quantification.

The allocating module 8052 is adapted to distribute the bandwidth to the video signal in each channel according to the proportional relationship among the current-video-sequence complexity level of the video signal in each channel calculated by the calculating module 8051.

Furthermore, the allocating module 8052 is further adapted to distribute the bandwidth to the video signal in each channel according to the proportional relationship among the current-video-sequence complexity level of the video signal in each channel calculated by the calculating module 8051 together with a priority order of the video signal in each channel.

It is assumed that the proportional relationship among the current-video-sequence complexity levels of video signals in channels 1, 2, 3, and 4 calculated by the calculating module 8051 is 1:2:4:1, and when the allocating module 8052 distributes a total bandwidth of 100 M (assumed) to the video signals in the channels 1, 2, 3, and 4, the bandwidths obtained by the video signals in the channels 1, 2, 3, and 4 are respectively 12.5 M, 25 M, 50 M, and 12.5 M.

It is further assumed that the proportional relationship among the current-video-sequence complexity levels of video signals in channels 1, 2, and 3 calculated by the calculating module 8051 is 1:2:3, and priority orders of the video signals in the channels 1, 2, and 3 are respectively a third priority, a second priority, and a first priority. When the allocating module 8052 distributes a total bandwidth of 120 M (assumed) to the video signals in the channels 1, 2, and 3, a bandwidth of 60 M is firstly distributed to the video signal in the channel 3, then a bandwidth of 40 M is distributed to the video signal in the channel 2, and finally a bandwidth of 20 M is distributed to the video signal in the channel 1.

Functions of the video signal processing device according to the embodiment of the present invention may be specifically realized by adding functions of the bandwidth control device according to the third embodiment to the functions of the existing DVS/DVR apparatus.

Through the video signal processing device according to the fourth embodiment of the present invention, when the content of a video signal in a certain channel is suddenly changed, the bandwidth of the video signal in the channel is increased, and the bandwidth of the video signal in the other one or several channels is reduced, so as to dynamically distribute the bandwidth to the video signal in each channel and further lower the occurrence probability of video quality deterioration while maintaining the total bandwidth unchanged.

### Fifth Embodiment

FIG. 9 is a schematic diagram of a logical structure of a bandwidth control system according to a fifth embodiment of the present invention. Referring to FIG. 9, the bandwidth control system according to the embodiment of the present invention includes a video capturing device 901 and a video signal processing device 902.

The video capturing device 901 is adapted to capture a video signal in each channel.

The video signal processing device 902 is adapted to receive the video signal in each channel provided by the video capturing device 901; encode the video signal in each channel, and obtain complexity information about the current video sequence of the video signal in each channel; quantify the complexity information about the current video sequence of the video signal in each channel, and obtain a current-video-sequence complexity level of the video signal in each channel according to the complexity information; and distribute a bandwidth to the video signal in each channel according to the current-video-sequence complexity level of the video signal in each channel.

Preferably, the video capturing device 901 may be specifically a DVS/DVR apparatus added with the functions of the bandwidth control device according to the third embodiment.

In the bandwidth control system according to the fifth embodiment of the present invention, a total bandwidth can be dynamically distributed to a video signal in each channel, so that the video signal in each channel dynamically obtains a proper bandwidth, so as to reasonably utilize the total bandwidth, and further lower the occurrence probability of video quality deterioration.

Persons of ordinary skill in the art should understand that, all or a part of the steps of the method according to the embodiments of the present invention may be implemented by a program instructing relevant hardware. The program may be stored in a computer readable storage medium. When the program is executed, the steps of the method according to the embodiments of the present invention are performed. The storage medium may be any medium that is capable of storing program codes, such as a read-only memory (ROM), a random access memory (RAM), a magnetic disk, or an optical disk.

The bandwidth control method, the bandwidth control device, and the bandwidth control system of the present invention have been described in detail. The principle and implementation of the present invention are described herein through specific examples. The description about the embodiments of the present invention is merely provided for facilitating the understanding of the method and core ideas of the present invention. Persons of ordinary skill in the art can make variations and modifications to the present invention in terms of the specific implementations and application scopes according to the ideas of the present invention. Therefore, the specification shall not be construed as limitations to the present invention.

What is claimed is:

1. A bandwidth control method, comprising:
acquiring complexity information about the current video sequence of a video signal in each channel;
quantifying the complexity information about the current video sequence of the video signal in each channel, and obtaining a current-video-sequence complexity level of the video signal in each channel according to the complexity information; and
distributing a bandwidth to the video signal in each channel according to the current-video-sequence complexity level of the video signal in each channel.

2. The method according to claim 1, wherein the acquiring the complexity information about the current video sequence of the video signal in each channel further comprises:
receiving the complexity information about the current video sequence of the video signal in each channel sent by an encoding module corresponding to the video signal in each channel.

3. The method according to claim 2, wherein the complexity information about the current video sequence of the video signal in each channel is sent by the encoding module corresponding to the video signal in each channel after the encoding module encodes a current video sequence of an input video signal in one channel.

4. The method according to claim 1, wherein the quantifying the complexity information about the current video sequence of the video signal in each channel and obtaining the current-video-sequence complexity level of the video signal in each channel according to the complexity information further comprises:
quantifying the complexity information about the current video sequence of the video signal in each channel, and obtaining a quantified value of the complexity information about the current video sequence of the video signal in each channel; and
determining the current-video-sequence complexity level of the video signal in each channel according to the quantified value of the complexity information about the current video sequence of the video signal in each channel.

5. The method according to claims 1, wherein the distributing the bandwidth to the video signal in each channel according to the current-video-sequence complexity level of the video signal in each channel further comprises:
calculating a proportional relationship among the current-video-sequence complexity level of the video signal in each channel; and
distributing the bandwidth to the video signal in each channel according to the proportional relationship.

6. The method according to claims 3, wherein the distributing the bandwidth to the video signal in each channel according to the current-video-sequence complexity level of the video signal in each channel further comprises:
calculating a proportional relationship among the current-video-sequence complexity level of the video signal in each channel; and
distributing the bandwidth to the video signal in each channel according to the proportional relationship.

7. The method according to claims 4, wherein the distributing the bandwidth to the video signal in each channel according to the current-video-sequence complexity level of the video signal in each channel further comprises:
calculating a proportional relationship among the current-video-sequence complexity level of the video signal in each channel; and
distributing the bandwidth to the video signal in each channel according to the proportional relationship.

8. The method according to claim 5, further comprising:
distributing the bandwidth to the video signal in each channel according to the proportional relationship together with a priority order of the video signal in each channel.

9. The method according to claim 6, further comprising:
distributing the bandwidth to the video signal in each channel according to the proportional relationship together with a priority order of the video signal in each channel.

10. The method according to claim 1, wherein the complexity information about the current video sequence of the video signal in each channel is a peak signal to noise ratio (PSNR) of a current video sequence of the video signal in each channel.

11. A bandwidth control device, comprising:
an acquiring module, adapted to acquire complexity information about the current video sequence of a video signal in each channel;
a quantifying module, adapted to quantify the complexity information about the current video sequence of the video signal in each channel, and obtain a current-video-sequence complexity level of the video signal in each channel according to the complexity information; and
a distributing module, adapted to distribute a bandwidth to the video signal in each channel according to the current-video-sequence complexity level of the video signal in each channel.

12. The device according to claim 11, wherein the acquiring module further comprises:
a receiving module, adapted to receive the complexity information about the current video sequence of the video signal in each channel sent by an encoding module corresponding to the video signal in each channel.

13. The device according to claim 11, wherein the quantifying module further comprises:
a quantifying sub-module, adapted to quantify the complexity information about the current video sequence of the video signal in each channel, and obtain a quantified value of the complexity information about the current video sequence of the video signal in each channel; and
a determination module, adapted to determine the current-video-sequence complexity level of the video signal in each channel according to the quantified value of the complexity information about the current video sequence of the video signal in each channel.

14. The device according to claim 13, wherein the distributing module further comprises:
a calculating module, adapted to calculate a proportional relationship among the current-video-sequence complexity level of the video signal in each channel; and
an allocating module, adapted to distribute the bandwidth to the video signal in each channel according to the proportional relationship.

15. The device according to claim 14, wherein the allocating module is further adapted to distribute the bandwidth to the video signal in each channel according to the proportional relationship together with a priority order of the video signal in each channel.

16. A video signal processing device, applicable to acquire and process video signals in several channels, comprising:
a first receiving module, adapted to receive a video signal in each channel provided by a video capturing device;
an encoding module, adapted to encode the video signal in each channel, and obtain complexity information about the current video sequence of the video signal in each channel;
a second receiving module, adapted to receive the complexity information about the current video sequence of the video signal in each channel sent by the encoding module;
a quantifying module, adapted to quantify the complexity information about the current video sequence of the video signal in each channel, and obtain a current-video-sequence complexity level of the video signal in each channel according to the complexity information; and
a distributing module, adapted to distribute a bandwidth to the video signal in each channel according to the current-video-sequence complexity level of the video signal in each channel.

17. The device according to claim 16, wherein the quantifying module further comprises:
a quantifying sub-module, adapted to quantify the complexity information about the current video sequence of the video signal in each channel, and obtain a quantified value of the complexity information about the current video sequence of the video signal in each channel; and
a determination module, adapted to determine the current-video-sequence complexity level of the video signal in each channel according to the quantified value of the complexity information about the current video sequence of the video signal in each channel.

18. The device according to claim 16, wherein the distributing module further comprises:
a calculating module, adapted to calculate a proportional relationship among the current-video-sequence complexity level of the video signal in each channel; and
an allocating module, adapted to distribute the bandwidth to the video signal in each channel according to the proportional relationship.

19. The device according to claim 17, wherein the allocating module is further adapted to distribute the bandwidth to the video signal in each channel according to the proportional relationship together with a priority order of the video signal in each channel.

20. A bandwidth control system, comprising:
a video capturing device, adapted to capture a video signal in each channel; and
a video signal processing device, adapted to receive the video signal in each channel provided by the video capturing device; encode the video signal in each channel, and obtain complexity information about the current video sequence of the video signal in each channel; quantify the complexity information about the current video sequence of the video signal in each channel, and obtain a current-video-sequence complexity level of the video signal in each channel according to the complexity information; and distribute a bandwidth to the video signal in each channel according to the current-video-sequence complexity level of the video signal in each channel.
